(19) United States
(12) Patent Application Publication
(10) Pub. No.: US 2010/0209759 A1
(43) Pub. Date: Aug. 19, 2010

(54) BATTERY PACK

(76) Inventors: Marcin Rejman, Waiblingen (DE); Wolf Matthias, Stuttgart (DE); Josef Baumgartner, Stuttgart (DE); Jan Breitenbach, Stuttgart (DE); Thorsten Seidel, Remseck am Neckar (DE); Rainer Glauning, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/678,217

(22) PCT Filed: Aug. 26, 2008
(86) PCT No.: PCT/EP2008/061124

§ 371 Date: Mar. 15, 2010

(30) Foreign Application Priority Data
Sep. 21, 2007 (DE) 20 2007 014 418.0
Oct. 15, 2007 (DE) 10 2007 049 358.6

(51) Int. Cl. H01M 6/42

(52) U.S. Cl. 429/156

(57) ABSTRACT

The invention describes a battery pack having a housing and at least one battery cell. According to the invention, also provided are elements which compensates for tolerance variations of the battery cell(s). The tolerance compensation elements include at least one spreading element which is arranged in an intermediate space between at least two battery cells and/or between one battery cell and the housing.

### PRIOR ART

The invention relates to a battery pack, in particular for a handheld power tool, as generically defined by the preamble to claim 1.

Instead of being supplied with power through a cord, numerous handheld power tools are equipped with rechargeable battery packs. The battery packs comprise a plurality of electrically connected battery cells that are accommodated in a housing. Usually, the battery cells have an essentially cylindrical shape. The mechanical dimensions are as a rule subject to international standards, but these allow very wide tolerances. The tolerances are in the range of up to 1 mm, which in comparison with tolerance field magnitudes otherwise usual in construction, of 0.2 to 0.4 mm, for the same primary dimensions means markedly greater tolerance.

As a consequence of these great tolerances, it is necessary to construct the housing of the battery pack for the largest size. However, this means that some or all of the battery cells in the housing are received with play. In that case, the play is compensated for, for instance by foam inserts. These foam inserts, however, have the disadvantage that first, because of possible residual pressure deformation, the mechanical tension of the foam insert decreases over time, so that the battery cells in the housing gain increasing play again and are no longer firmly seated. Second, foam inserts have the disadvantage that they have a good thermal insulation effect. In a battery pack, this is unwanted, since the heat produced in operation or in charging of the battery pack has to be dissipated as quickly as possible.

Alternatively, it is known from the prior art to provide an elastic housing, to compensate for the tolerances in diameter of the cells. An elastic housing is disadvantageous since the design of the battery pack is then strongly influenced by the elasticity of the housing. Moreover, the other components, such as screw fastenings, must also be adapted to the elasticity of the housing. Finally, an elastic housing is not advantageous since, because of the elastic deformation of the housing and depending on the actual dimensions, the battery cells contained in the housing are variously heavily loaded mechanically.

### DISCLOSURE OF THE INVENTION

The invention is based on a battery pack having a housing and at least one battery cell and also having means for compensating for tolerances of the battery cell. There may also be more than one battery cell; for instance, two or more battery cells are connected together to make a battery pack. The battery pack is especially well suited for supplying power to an electrical device and very particularly a handheld power tool. The battery cells typically have a cylindrical shape. However, in principle, they may have any other geometrical shape instead.

According to the invention, the tolerance compensation means have at least one spreader element, which is disposed in an interstice between at least two battery cells and/or between the one battery cells and the housing. The housing of the battery pack is preferably dimensionally stable. In the structural sense, it can be considered to be rigid. With the aid of the spreader elements, it is possible to compensate for the tolerances of the battery cells in the dimensionally stable housing without the outer contour of the housing changing substantially. The spreader elements absorb the play between the battery cells and/or between the battery cells and the housing that occurs because of the dimensional tolerances of the battery cells.

The spreader element can be disposed between two adjacent battery cells, for example. However, it can also be placed in the interstice between three adjacent battery cells that are arranged in approximately triangular fashion relative to one another. If there are at least four battery cells, disposed in the form of a square relative to one another, then the spreader element can be disposed in the interstice between these four battery cells. The spreader element may also be disposed between the inner wall of the battery pack housing and one battery cell, or between the inner wall of the battery pack housing and two adjacent battery cells that both contact the inner wall.

In a first embodiment, the spreader element is intrinsically dimensionally elastic. In particular, it is dimensioned larger than the interstice between the battery cells and/or between the battery cells and the housing, so that upon the insertion of the spreader element into the interstice, the battery cells adjoining the interstice are forced apart. The dimensionally elastic spreader element can in principle be made from an elastomer material. However, it is preferably made from a thermoplastic material, and although individual portions of the spreader element are essentially rigid, the spreader element as a whole has adequate elasticity, because of its shape.

Preferably, the spreader elements are of high density polyethylene (PE HD), which has the advantage on the one hand that it is elastic and deformable and on the other, with a thermal conductivity of from 0.4 to 0.42 W/mK, that its thermal conductivity is relatively good for plastics and is comparable to the thermal conductivity of the battery cells themselves, which is from 0.4 to 0.5 W/mK. The spreader elements can be produced by injection molding, for example.

In a second embodiment, the spreader element has at least one elastic element. Load-bearing portions of the spreader element are of an essentially rigid material, such as a thermoplastic. At least one elastic element is disposed between the load-bearing portions and has the effect that upon insertion of the spreader element into the interstice between the battery cells, and/or between the battery cells and the housing, the battery cells adjoining the interstice are forced apart. The elastic element can be formed on the one hand of an elastomer material, such as an elastomer plastic. This has the advantage that it can be integrally formed directly onto the load-bearing portions, for instance in a two-component injection molding process. On the other hand, the elastic element can be a spring element instead, which is either integrally formed onto the load-bearing portions, for instance being a plastic spring element, or is embodied as a separate element.

Preferably, at least one wall of the spreader element is adapted to the contour of the battery cells in such a way that the spreader element conforms to the battery cells. The outer wall of the spreader element, which rests on the circumferential surface of a battery cell, thus forms a face that is complementary to the circumferential surface of the battery cells.

In a preferred embodiment, the spreader element is formed of a plurality of walls, which define a hollow space. This has the advantage that even after the installation of the spreader element in an interstice between two or more cells and/or between battery cells and the housing, there is a hallow space in the interstice between the cells. This hollow space can serve the purpose of cooling the battery cells, for instance with cooling air or some other heat-dissipating medium flowing the hollow space. It is known from the prior art to generate a cooling air flow in a battery pack with the aid of a blower in a handheld power tool or a charger.

Advantageously, the shape of the spreader element is also designed with a view to the heat transfer between the battery cells. In a region where a heat transfer between two adjacent battery cells is desired and is to be reinforced, the spreader element disposed between the battery cells is of a kind such that a good heat transfer is possible. This can be attained by providing that adjacent walls of the spreader element are disposed contacting one another. Between the walls that contact one another, there should be no air gap, because an air gap would greatly reduce the heat transfer. The contacting walls can for instance be walls that merge with one another and are thus embodied in one piece.

By comparison, in a region in which a heat transfer between two adjacent battery cells is unwanted and must be suppressed as extensively as possible, the spreader element between the battery cells is of a kind such that the heat transfer is reduced as much as possible; that is, good heat transfer is not possible. This can be attained by providing an air gap, which hinders the heat transfer; between adjacent walls of the spreader element. In that region where no heat transfer is intended, the disposition of adjacent walls of the spreader element such that they contact one another is thus precisely avoided.

For easier installation of the spreader element, an insertion aid is preferably provided on the spreader element. This can in particular be an insertion chamfer, so that the spreader element has a lesser diameter on its face end toward the battery cells upon installation than on its opposed face end. As a result, upon the introduction of the spreader element into the interstice between adjacent battery cells, the battery cells are gradually spread apart.

A spreader element, which can be disposed between two or more battery cells or between the housing and one or more battery cells, can for example have essentially the same axial length as the battery cells. As a result, the battery cells can be reliably and uniformly forced apart over their entire axial length. Alternatively, in the interstice between two or more battery cells or between one or more battery cells and the housing, one spreader element can be introduced from each of the two face ends of the battery cells, this spreader element being relatively short in comparison to the axial length of the battery cells. This has the advantage that the spreader elements can be easily introduced, since the requisite pressing force is less than for comparatively long spreader elements. Nevertheless, uniform spreading of the battery cells is achieved.

A further subject of the invention is a handheld power tool that contains at least one battery pack according to the invention.

The invention will be described in further detail below in conjunction with the accompanying drawings.

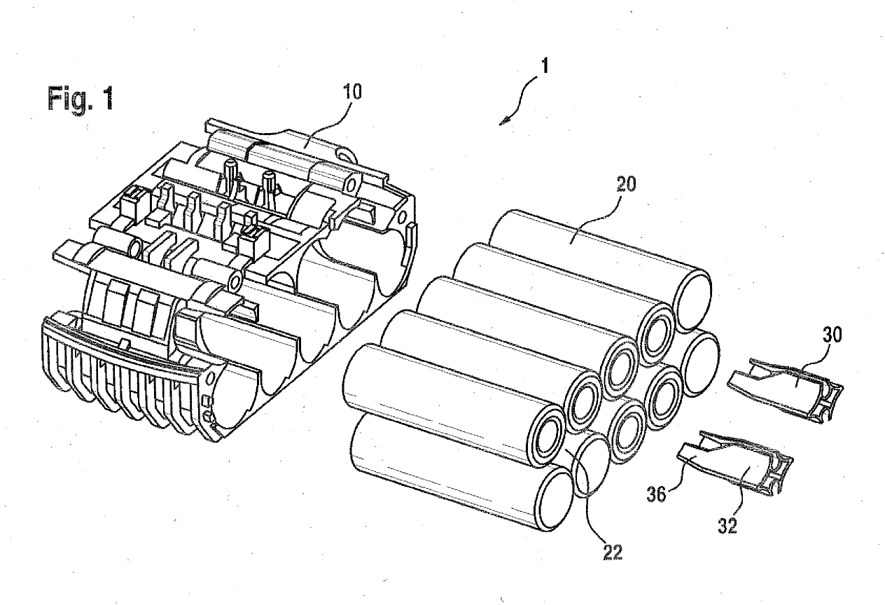

FIG. 1 is an exploded view of a battery pack of the invention;

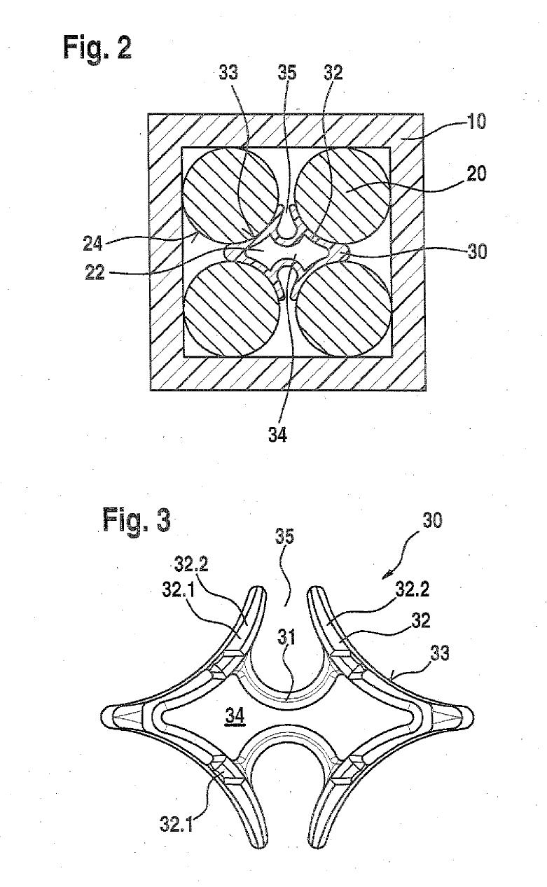

FIG. 2 is a cross section through a battery pack of the invention;

FIG. 3 shows a spreader element in cross section;

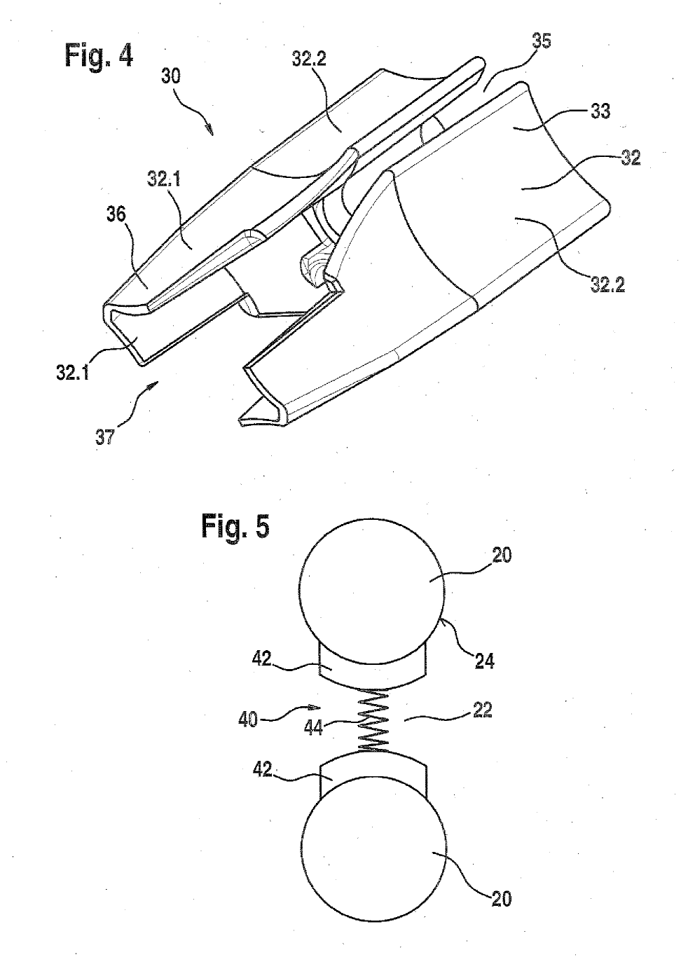

FIG. 4 shows the spreader element of FIG. 3 in perspective;

FIG. 5 shows an alternative form of a spreader element in a schematic illustration.

The exploded view in FIG. 1 shows a battery pack 1 with a housing 10 of plastic, a plurality of cylindrical battery cells 20, and a plurality of spreader elements 30. In the embodiment shown, ten battery cells 20 are arranged in two parallel rows of five battery cells 20 each, side by side. FIG. 1 shows only two spreader elements 30 for the sake of simplicity. Preferably, however, one spreader element 30 is always provided in an interstice 22 formed by four adjacent battery cells 20. For complete installation of the battery pack 1, for instance in a handheld power tool (not shown), the housing 10 includes further housing parts, such as side walls, as well as electrical contacts, which are not shown here for the sake of greater clarity.

The housing 10 of the battery pack 1 is dimensionally stable. The spreader elements 30 have the effect that the battery cells 20, despite their sometimes considerable dimensional tolerances, are received in the battery pack housing 10 essentially without play. The outer contour of the housing 10 does not undergo any deformation.

The spreader element 30 is intrinsically dimensionally elastic. It comprises PE HD, which in comparison to other thermoplastics is comparatively elastic and deformable. The spreader element as a whole, because of its shape, has adequate elasticity. In the uninstalled state, it is larger in diameter than the interstice 22 between the battery cells 20. As a result, upon insertion of the spreader element 30 into the interstice 22, the battery cells 20 adjoining the interstice 22 are forced apart.

As can be seen in FIG. 2, the spreader element 30 contacts the circumferential surfaces 24 of the four battery cells 20. To that end, the spreader element 30 includes four walls 32, which are adapted to the circumferential surfaces 24 of the battery cells 20 in such a manner that the spreader element 30 conforms to the battery cells 20. The outer face 33 of the walls 32 of the spreader element 30 thus forms a face that is complementary to the circumferential surface 24 of the battery cells 20.

In FIG. 3, it is shown that the walls 32 of the spreader element 30, together with further walls 31, define a hollow space 34. Thus even after the installation of the spreader element 30 in the interstice 22, there is a hollow space, which serves the purpose of cooling the battery cells, for instance by means of cooling air.

If a battery pack 1 comprises a plurality of battery cells 20, as shown for instance in FIG. 1, then it can be desirable if the heat transfer in the battery pack 1 between adjacent battery cells 20 is not effected equally well in all directions. The battery pack 1 shown in FIG. 1 is mounted by its top side on a handheld power tool. In this battery pack 1, there should be a good heat transfer in the vertical direction, that is, between a battery cell 20 of one row and an adjacent battery cell of the other row. Conversely, in the horizontal direction, that is, between adjacent battery cells of one row, the heat transfer should be reduced as sharply as possible. The spreader element 30 is designed in a special way for that purpose in that vertically adjacent walls 32.1 are disposed contacting one another, so that between the walls 32.1 or between the battery cells 20 located one above the other, there is no air gap that could reduce the heat transfer. Thus the two walls 32.1 are designed such that they merge with one another. They are embodied in one piece. Horizontally adjacent walls 32.2, conversely, do not contact one another. As a result of their curvature, the walls 32.2 do extend toward one another, but do not touch one another. Thus an air gap 35 forms between the walls 32.2 and hence between the horizontally adjacent battery cells 20.

The spreader element 30 is also provided with an insertion aid 36, which makes the installation of the spreader element easier. Insertion chamfers serve as the insertion aid 36 and with their aid the spreader element 30 upon insertion slides along the battery cells 20 in order to spread them apart. Because of the insertion aid 36 in the form of insertion chamfers, the spreader element 30 has a lesser diameter on its face end 37 that upon installation is toward the battery cells 20 than on its opposite face end.

As can be seen from FIGS. 1 and 4, the spreader element 30 is embodied as relatively short in comparison to the axial length of the battery cells 20. This has the advantage that upon insertion of the spreader element 30 into the interstice 22, only a short distance has to be covered, and thus the requisite pressing force is comparatively slight. So that nevertheless uniform spreading over the entire axial length of the battery cells 20 will be achieved, one spreader element 30 is introduced into the interstice 22 from each of the two face ends of the battery cells 20. Alternatively, the spreader elements 30 could be embodied as longer, but with the disadvantage that the pressing force upon insertion would be greater.

In FIG. 5, an alternative embodiment of a spreader element 40 is shown schematically. Here, there is one spreader element 40 between two adjacent battery cells 20. The spreader element 40 has an elastic element 44, which connects the load-bearing portions 42 of the spreader element 40. The load-bearing portions 42 are dimensionally stable and are for instance of PE HD. They are shaped such that they contact the circumferential surface 24 of the battery cells 20. The elastic element 44, conversely, acts as a spring element. It is shown schematically in FIG. 5 as a helical spring. However, any kind of spring element may be used, such as a resilient element of an elastomer material. Upon insertion of the spreader element 40 into the interstice 22 between the two battery cells 20, the battery cells 20 adjoining the interstice 22 are forced apart.

1-11. (canceled)

12. A battery pack, comprising:
a housing;
at least one battery cell disposed in the housing; and
compensating means for compensating for tolerances of the battery cell, the compensation means having at least one spreader element, which is disposed in an interstice between at least two battery cells and/or between one battery cell and the housing.

13. The battery pack as defined by claim 12, wherein the spreader element is intrinsically dimensionally elastic.

14. The battery pack as defined by claim 13, wherein the dimensionally elastic spreader element is dimensioned as larger than the interstice, so that upon insertion of the spreader element into the interstice, the battery cells adjoining the interstice are forced apart by the spreader element.

15. The battery pack as defined by claim 12, wherein the spreader element has at least one elastic element.

16. The battery pack as defined by claim 13, wherein the spreader element has at least one elastic element.

17. The battery pack as defined by claim 14, wherein the spreader element has at least one elastic element.

18. The battery pack as defined by claim 15, wherein upon insertion of the spreader element into the interstice, the elastic element forces apart the battery cells that adjoin the interstice.

19. The battery pack as defined by claim 16, wherein upon insertion of the spreader element into the interstice, the elastic element forces apart the battery cells that adjoin the interstice.

20. The battery pack as defined by claim 17, wherein upon insertion of the spreader element into the interstice, the elastic element forces apart the battery cells that adjoin the interstice.

21. The battery pack as defined by claim 12, wherein at least one wall of the spreader element is adapted to the circumferential surface of the battery cells, in such a manner that the spreader element conforms to the battery cells.

22. The battery pack as defined by claim 20, wherein at least one wall of the spreader element is adapted to the circumferential surface of the battery cells, in such a manner that the spreader element conforms to the battery cells.

23. The battery pack as defined by claim 12, wherein the walls of the spreader element define a hollow space.

24. The battery pack as defined by claim 22, wherein the walls of the spreader element define a hollow space.

25. The battery pack as defined by claim 12, wherein a first pair of adjacent walls of the spreader element contact one another, so that a good heat transfer therebetween is possible.

26. The battery pack as defined by claim 24, wherein a first pair of adjacent walls of the spreader element contact one another, so that a good heat transfer therebetween is possible.

27. The battery pack as defined by claim 12, wherein between adjacent walls of the spreader element, an air gap is embodied, so that heat transfer therebetween is reduced.

28. The battery pack as defined by claim 25, wherein between a second pair of adjacent walls of the spreader element, an air gap is embodied, so that the heat transfer therebetween is reduced.

29. The battery pack as defined by claim 12, wherein the spreader element has an insertion aid.

30. The battery pack as defined by claim 28, wherein the spreader element has an insertion aid.

31. A handheld power tool containing at least one battery pack as defined by claim 12.
